(19) United States
(12) Patent Application Publication
(10) Pub. No.: US 2015/0110530 A1
(43) Pub. Date: Apr. 23, 2015

(54) FIXING DEVICE AND IMAGE FORMING APPARATUS

(71) Applicant: FUJI XEROX CO., LTD., Tokyo (JP)

(72) Inventors: Yasuhiro UEHARA, Kanagawa (JP); Mitsuhiro MATSUMOTO, Kanagawa (JP); Kazuyoshi ITO, Kanagawa (JP); Mikio SAIKI, Kanagawa (JP); Hideaki OHARA, Kanagawa (JP)

(73) Assignee: FUJI XEROX CO., LTD., Tokyo (JP)

(21) Appl. No.: 14/297,919

(22) Filed: Jun. 6, 2014

(30) Foreign Application Priority Data
Oct. 17, 2013 (JP) 2013-216375

(51) Int. Cl. G03G 15/20

(52) U.S. Cl. CPC G03G 15/2053
USPC 399/329

(57) ABSTRACT

Provided is a fixing device including a fixing belt that is formed in an endless shape, is driven to rotate, and includes an outer circumferential surface pressed to a recording sheet holding a toner image, and a thin plate shaped heating member that contacts with an inner circumferential surface of the fixing belt to generate heat and heats the fixing belt, wherein the heating member is supported to be fixed at one end portion in a circumferential direction of the fixing belt, contacts with the fixing belt along the circumferential direction, is elastically deformed so that a shape of the heating member is restrained by the fixing belt, and is pressed to the circumferential surface of the fixing belt by an elastic repulsive force.

### CROSS-REFERENCE TO RELATED APPLICATIONS

This application is based on and claims priority under 35 USC 119 from Japanese Patent Application No. 2013-216375 filed Oct. 17, 2013.

### BACKGROUND

(i) Technical Field

The present invention relates to a fixing device and an image forming apparatus.

(ii) Related Art

In an electrophotographic image forming apparatus, toner is attached to a latent image by an electrostatic potential difference to be visualized, and a formed toner image is transferred to a recording medium. Moreover, the toner image is fixed to the recording medium by a fixing device. As the fixing device, a fixing device is widely known in which a heated fixing member is pressed to the toner image on the recording medium, and is heated and pressurized. When a recording sheet is fed to the fixing device, it is necessary to heat the fixing member to a temperature at which fixing can be performed. Accordingly, some time until the fixing member is heated to a fixable temperature is required when an image forming operation starts, and in order to decrease the required time, it is widely used to maintain the fixing member in a standby state to be heated to a predetermined temperature.

In a device in which the fixing member is heated in advance and is in a standby state, power is consumed even when the fixing member is in a standby state. Accordingly, it is preferable that both a decrease in power consumption at the standby state and a decrease in a return time until the fixing of the image can be performed be achieved, and thus, a decrease in heat capacity of the fixing member is recommended.

### SUMMARY

According to an aspect of the invention, there is provided a fixing device including:

a fixing belt that is formed in an endless shape, is driven to rotate, and includes an outer circumferential surface pressed to a recording sheet holding a toner image; and

a thin plate shaped heating member that contacts with an inner circumferential surface of the fixing belt to generate heat and heats the fixing belt,

wherein the heating member is supported to be fixed at one end portion in a circumferential direction of the fixing belt, contacts with the fixing belt along the circumferential direction, is elastically deformed so that a shape of the heating member is restrained by the fixing belt, and is pressed to the circumferential surface of the fixing belt by an elastic repulsive force.

### BRIEF DESCRIPTION OF THE DRAWINGS

Exemplary embodiments of the present invention will be described in detail based on the following figures, wherein:

FIG. 1 is a schematic configurational view of an image forming apparatus that is an exemplary embodiment of the present invention;

FIG. 2 is a schematic cross-sectional view of a fixing device that is an exemplary embodiment of the present invention and may be used in the image forming apparatus illustrated in FIG. 1;

FIG. 3 is a schematic cross-sectional view illustrating a state when a shape of a heating member used in the fixing device illustrated in FIG. 2 is not restrained by a fixing belt;

FIG. 4 is a schematic perspective view illustrating a state when the shape of the heating member used in the fixing device illustrated in FIG. 2 is not restrained by the fixing belt;

FIG. 5 is a schematic view illustrating a cross-sectional shape when the shape of the heating member used in the fixing device illustrated in FIG. 2 is not restrained by the fixing belt;

FIG. 6 is an enlarged cross-sectional view of the heating member illustrated in FIG. 3;

FIG. 7 is a schematic developed view illustrating a heat generation layer of the heating member illustrated in FIG. 3;

FIGS. 8A and 8B are a schematic perspective view illustrating another example of the heating member that may be used in the fixing device illustrated in FIG. 2 and a schematic perspective view of a band-shaped spring member that is used in the heating member;

FIG. 9 is a schematic perspective view illustrating a change of the shape when the heating member illustrated in FIG. 3 is heated in the state where the shape of the heating member is not restrained;

FIG. 10 is a schematic cross-sectional view of a fixing device that is another exemplary embodiment of the present invention;

FIG. 11 is a schematic cross-sectional view of a fixing device that is still another exemplary embodiment of the present invention;

FIG. 12 is a schematic cross-sectional view of a fixing device that is still another exemplary embodiment of the present invention; and

FIG. 13 is a schematic cross-sectional view illustrating an example of a fixing device in the related art.

### DETAILED DESCRIPTION

Hereinafter, an exemplary embodiment of the present invention will be described with reference to the drawings.

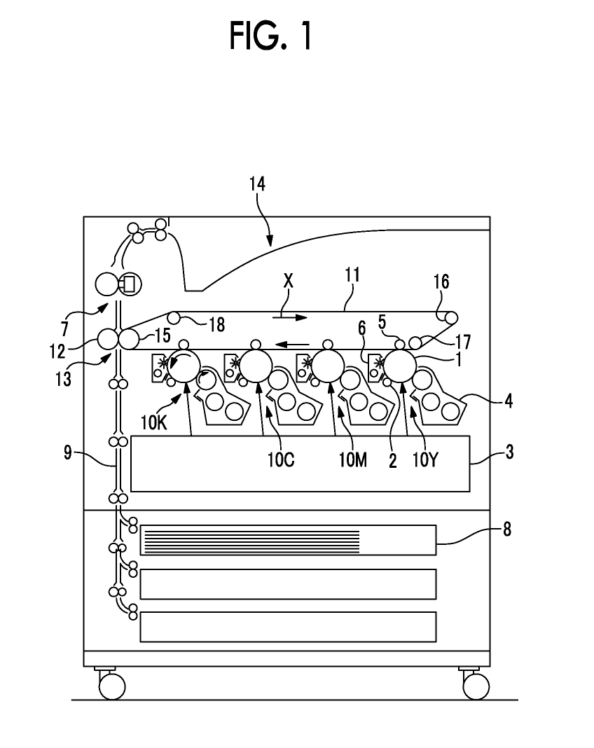

FIG. 1 is a schematic configurational view of an image forming apparatus that is an exemplary embodiment of the present invention.

The image forming apparatus forms color images using four color toners, and includes electrophotographic image forming units 10Y, 10M, 10C, and 10K that output images of colors such as yellow (Y), magenta (M), cyan (C), and black (K), and an intermediate image transfer belt 11 that opposes the image forming units.

The intermediate image transfer belt 11 is formed in an endless shape, and is stretched among an opposing roll 15 that is rotated, an adjustment roll 16 that adjusts deviation in a width direction of the intermediate image transfer belt 11, and two support rolls 17 and 18. Moreover, the opposing roll 15 is driven, and accordingly, a circumferential surface of the roll is driven to rotate in an arrow X direction illustrated in FIG. 1.

The image forming unit 10Y that forms a yellow toner image, the image forming unit 10M that forms a magenta toner image, the image forming unit 10C that forms a cyan toner image, and the image forming unit 10K that forms a black toner image are arranged in the order from an upstream side in a rotating movement direction of the intermediate image transfer belt 11. In downstream sides of positions to which the image forming units are opposite, a secondary image transfer roll 12 for performing secondary image transfer contacts with the intermediate image transfer belt 11 and is placed to oppose the opposing roll 15. A recording sheet that is a recording medium is fed to a secondary image transfer position 13 of the secondary image transfer roll 12 opposing the intermediate image transfer belt 11 via a transport path 9 from a recording sheet accommodating section 8.

Meanwhile, a fixing device 7 that heats and pressurizes the toner images and crimps the toner images on the recording sheet is provided on the downstream side of the secondary image transfer position 13 in the transport pathway of the recording sheet. Moreover, a discharged paper holding section 14 that holds recording sheets, to which toner images are fixed, to be overlapped with one another are provided on the further downstream side.

Each of the image forming units 10 includes a photoconductor drum 1 that has a surface on which an electrostatic latent image is formed and functions as an image holding member, and in the vicinity of each photoconductor drum 1, a charging device 2 that charges the surface of the photoconductor drum 1, a developing device 4 that selectively transfers the toner to the electrostatic latent image formed on the photoconductor drum 1 to form the toner image, a primary image transfer roll 5 that performs primary image transfer on the intermediate image transfer belt 11 with respect to the toner image on the photoconductor drum 1, and a cleaning device 6 that removes the toner remaining on the photoconductor drum 1 after the transfer are provided. In addition, an exposure device 3 that generates image light based on image signals is provided in each of the photoconductor drum 1, the image light is radiated to each photoconductor drum 1 from the exposure device 3, and thus, the electrostatic latent image is written to a charged photoconductor drum 1.

The photoconductor drum 1 is formed by laminating a photosensitive layer on a conductive metal substrate having an endless shaped circumferential surface, and the circumferential surface is moved to be rotated. The metal substrate is electrically grounded. The photosensitive layer is formed in a functional separation type in which a charge generation layer and a charge transporting layer are sequentially laminated, and when a laser beam is radiated by the exposure device 3, the charging potential of the radiated portion is decreased.

The developing device 4 uses a two-component developer that includes toner and a magnetic carrier. Moreover, the developing device transfers the toner to the exposed portion of the surface of the photoconductor drum 1 at the position opposing the photoconductor drum 1, and forms a toner image as a visible image.

The cleaning device 6 is placed to oppose the circumferential surface of the photoconductor drum 1, and includes a cleaning blade that is supported to contact with the circumferential surface of the photoconductor drum 1. An edge portion of a tip of the cleaning blade contacts with the surface of the photoconductor drum 1, and scrapes and removes the toner or the like remaining on the photoconductor drum 1 after the primary image transfer is performed.

The intermediate image transfer belt 11 is inserted to be pressed between the secondary image transfer roll 12 and the opposing roll 15, and the secondary image transfer roll is rotated in a following manner by the rotation of the opposing roll 15. Moreover, a secondary image transfer voltage is applied between the secondary image transfer roll 12 and the opposing roll 15, and an electric field for transfer is formed. Accordingly, when the recording sheet is fed between the secondary image transfer roll 12 and the intermediate image transfer belt 11, the recording sheet is transported while being interposed between the secondary image transfer roll and the belt, and the toner image on the intermediate image transfer belt 11 is transferred to the recording sheet by the appliance of the electric field.

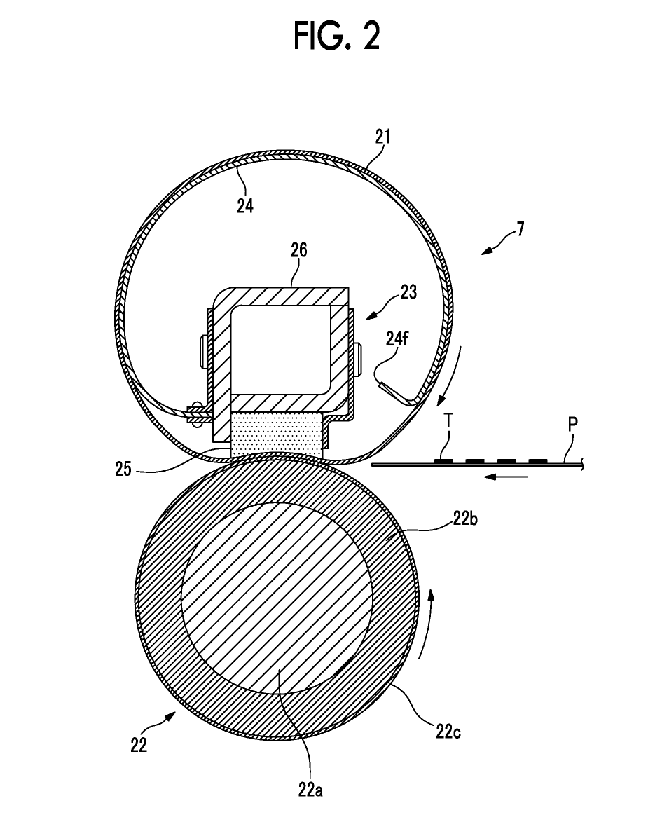

FIG. 2 is a schematic cross-sectional view illustrating the fixing device 7.

The fixing device 7 includes a fixing belt 21 that is formed in an endless shape and is driven to rotate, a pressure roll 22 that is placed to contact with the outer circumferential surface of the fixing belt 21, a pressing member 23 that is placed to oppose the pressure roll 22 inside the fixing belt 21 having an endless shape and includes the fixing belt 21 interposed between the outer circumferential surface of the pressure roll 22 and the pressing member 23, and a thin plate shaped heating member 24 that contacts with the inner circumferential surface of the fixing belt 21, generates heat, and heats the fixing belt 21. The fixing belt 21 is moved to be rotated by the rotation of the pressure roll 22, and the recording sheet P to which the toner image is transferred is fed between the pressure roll 22 and the fixing belt 21 that contact with each other. Moreover, a toner image T on the recording sheet P is pressed, heated, and pressurized by the fixing belt 21 heated by the heating member 24, and thus, the toner image T is fixed on the recording sheet P.

In the pressure roll 22, an elastic layer 22b is formed on the outer circumferential surface of a metal core 22a, and a surface layer 22c is laminated on the elastic layer. For example, the elastic layer 22b may be formed of a silicon sponge, and the thickness may be 5 mm. In addition, for example, the surface layer 22c may be formed of a fluororesin layer having a thickness of 30 μm. Moreover, in this example, an outer diameter of the pressure roll 22 is 28 mm.

In the fixing belt 21, a film shaped member including a base layer formed of a heat-resistance resin such as polyimide and a surface layer formed of a fluororesin laminated on the base layer is formed in an endless shape while the surface layer is positioned at the outside. For example, a thickness of the base layer may be 80 μm, and a thickness of the surface layer may be 30 μm. The fixing belt 21 is flexibly deformed when the belt is interposed between the pressure roll 22 and the pressing member 23. However, in a state where an external force is not applied to the belt, for example, when an axis is supported to be approximately vertical, a cross-section of the belt has an approximately circular cylinder shape by stiffness of the film shaped member. Moreover, for example, at this time, the outer diameter of the belt may be 30 mm. Moreover, a width in an axial direction, that is, the width in a width direction of the outer circumferential surface is larger than a width of the recording sheet P holding the toner image, and for example, the width may be 320 mm.

The pressing member 23 includes a pressing pad 25 that is pressed to the inner circumferential surface of the fixing belt 21, and a support section 26 that supports the pressing pad 25.

The pressing pad 25 continuously contacts with an approximately entire region in the width direction of the fixing belt 21, is elastically deformed, and presses the fixing belt 21 to the pressure roll 22. For example, the pressing pad 25 may be formed of an elastic material having heat resistance such as silicone rubber.

The support section 26 is formed in a bar shape by combining members in which cross-sectional shapes of metal plates are bent to be approximately L shapes, supports the pressing pad 25 in the axial direction, and is inserted into the inner side of the fixing belt 21 having a cylindrical shape. Moreover, the support section is supported by both end portions, and a pressing force is applied to the support section so that the pressing pad 25 is pressed to the pressure roll 22 side. In addition, for example, a resultant force of the forces pressed to the pressure roll 22 side may be 30 kg.

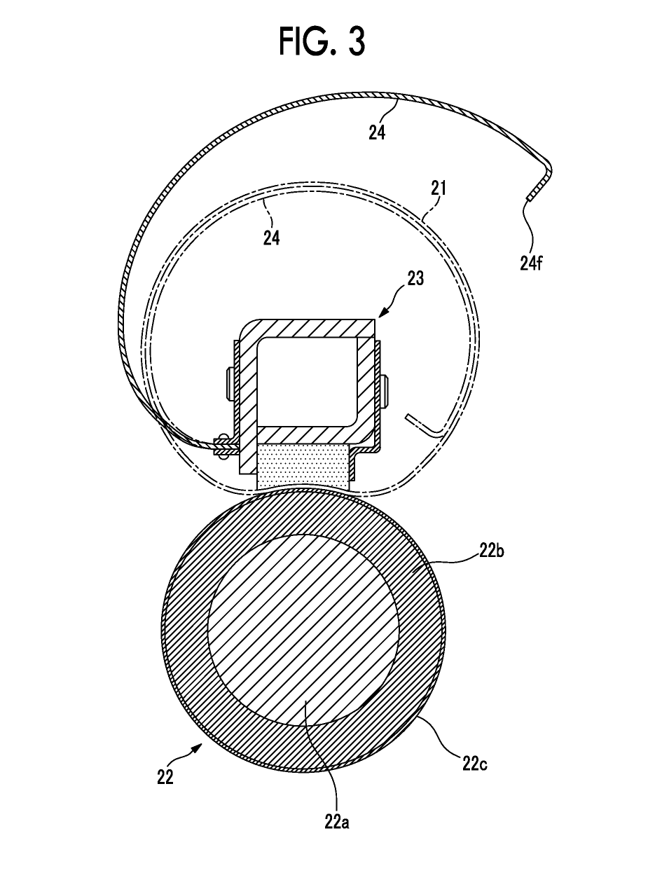

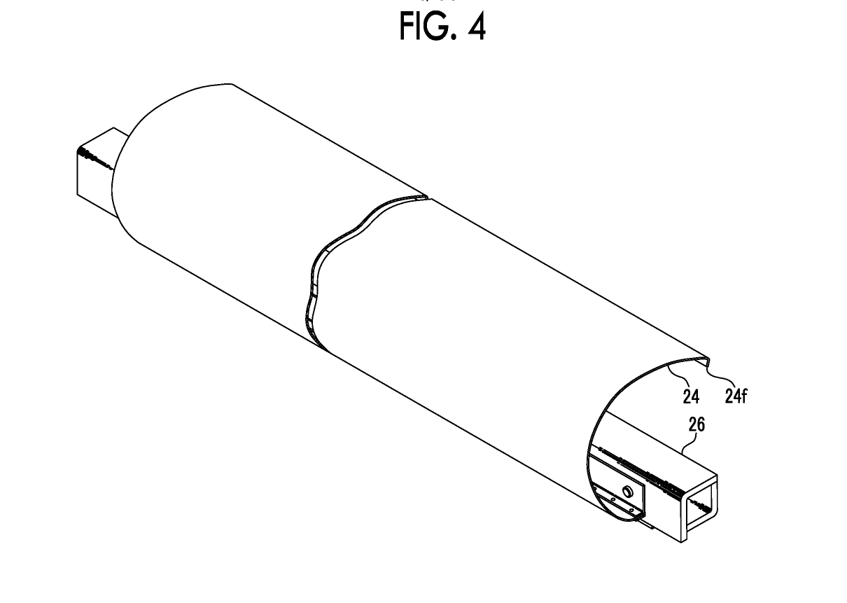

The heating member 24 is a thin plate shaped member that is elastically deformable and continues in the width direction of the circumferential surface of the fixing belt 21, and an end portion of the heating member on the upstream side in the rotating movement direction of the fixing belt 21 is supported to be fixed to the support section 26 of the pressing member 23. In addition, an end edge 24f on the downstream side in the rotating movement direction of the fixing belt 21 becomes a free end, and contacts along the inner circumferential surface of the fixing belt 21 by an elastic repulsive force of the heating member 24. That is, as illustrated in FIGS. 3 and 4, when the heating member 24 is supported to be fixed at the upstream side in the rotating movement direction of the fixing belt 21 and the shape of the heating member is not restrained by the fixing belt 21, the heating member 24 has a shape extending outside from the position of the fixing belt 21 in which a portion is supported to be interposed between the pressure roll 22 and the pressing member 23. In addition, when the heating member 24 is mounted inside the fixing belt 21, as shown by a dashed line in FIG. 3, the heating member 24 is elastically deformed, and the shape of the heating member is restrained by the fixing belt 21. At this time, the heating member is pressed to the inner circumferential surface of the fixing belt 21 by the elastic repulsive force, and a state where the heating member contacts with the inner circumferential surface in the circumferential direction is maintained.

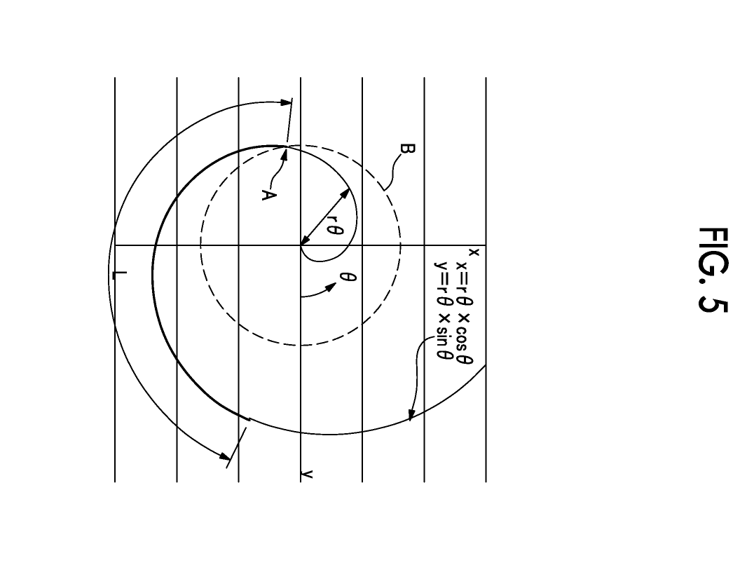

As illustrated in FIG. 3, the cross-sectional shape when the heating member 24 is not restrained by the fixing belt 21 is bent inside the fixing belt 21 having an endless shape, and a radius of curvature of the cross-sectional shape on the downstream side in the rotating movement direction of the fixing belt 21 from the fixed end portion is increased. For example, this shape may be set as illustrated in FIG. 5.

A spiral curve is set in which the radius of curvature is increased in proportion to an angle θ from a center when the cross-section of the fixing belt 21 is set to a circle. In a coordinate (X, Y) at a point on the spiral curve, X=rθ cos θ and Y=rθ sin θ are satisfied.

The spiral curve is drawn out by a range L having a predetermined length in a direction, in which the radius of curvature is increased, from a position A crossing a circle B when the cross-section of the fixing belt 21 is set to a circle, and the drawn curve becomes the cross-sectional shape in the range within which the heating member 24 and the fixing belt 21 contact with each other. Accordingly, in the range L, the radius of curvature of the cross-sectional shape of the heating member 24 is larger than a radius when the fixing belt 21 is set to a circle. Moreover, as illustrated in FIG. 2, the vicinity of the end edge 24f, which is the free end of the heating member 24, is bent inside the fixing belt 21, and bending stiffness in the width direction of the fixing belt 21 at the end portion is increased.

The fixing belt 21 is driven to rotate, and thus, the heating member 24 is rubbed against the inner circumferential surface of the fixing belt 21, and a friction force is applied to the inner circumferential surface. Moreover, the pressing pad 25 is also pressed to the inner circumferential surface of the fixing belt 21, and thus, a friction force is applied between the pressing pad and the fixing belt. Accordingly, the total of the friction force between the fixing belt 21 and the heating member 24 and the friction force between the fixing belt 21 and the pressing pad 25 is smaller than the friction force in which the pressure roll 22 is pressed to the outer circumferential surface of the fixing belt 21 and is operated as a driving force of the fixing belt 21, or a force that is transmitted from the pressure roll 22 to the fixing belt 21 in the state where the recording sheet is interposed between the fixing belt 21 and the pressure roll 22.

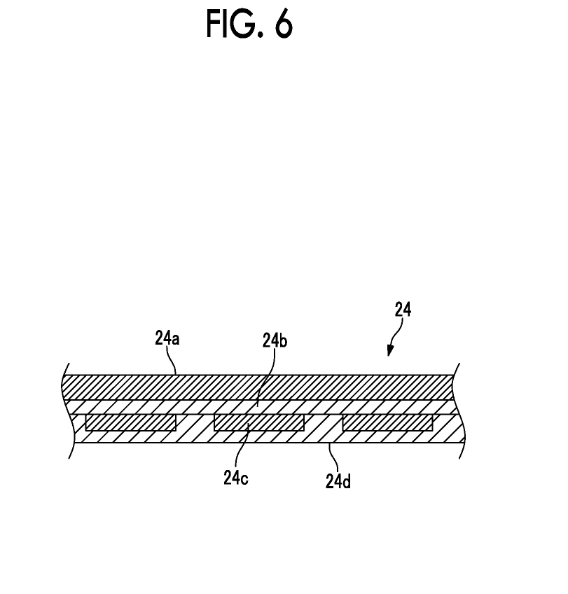

FIG. 6 is an enlarged cross-sectional view illustrating a cross-sectional configuration of the heating member 24.

In the heating member 24, a surface contacting with the inner circumferential surface of the fixing belt 21 is formed of a stainless steel, and becomes an elasticity giving layer 24a. An insulating layer 24b configured of a heat-resistance resin is formed on an inner side of the elasticity giving layer 24a on the heating member 24 having curvature, that is, a surface opposite to the surface of the elasticity giving layer 24a contacting with the fixing belt 21, and a heat generation layer 24c configured of stainless steel is formed on the insulating layer 24b. Moreover, the heat generation layer 24c is covered by a coating layer 24d configured of a heat-resistance resin.

For example, the elasticity giving layer 24a may have a thickness of 50 μm, the bending stiffness of the heating member 24 is mainly maintained by the elasticity giving layer 24a, and the elastic repulsive force is generated when bending deformation is generated. Accordingly, by adjusting the thickness of the elasticity giving layer 24a, adjustment of the elastic repulsive force, that is, a contact pressure between the fixing belt 21 and the heating member is adjustable.

The insulating layer 24b may be formed of a heat-resistance resin, in which a thickness is approximately 25 μm, such as polyimide, and a portion between the elasticity giving layer 24a and the heat generation layer 24c laminated on the insulating layer 24b is electrically insulated by the insulating layer.

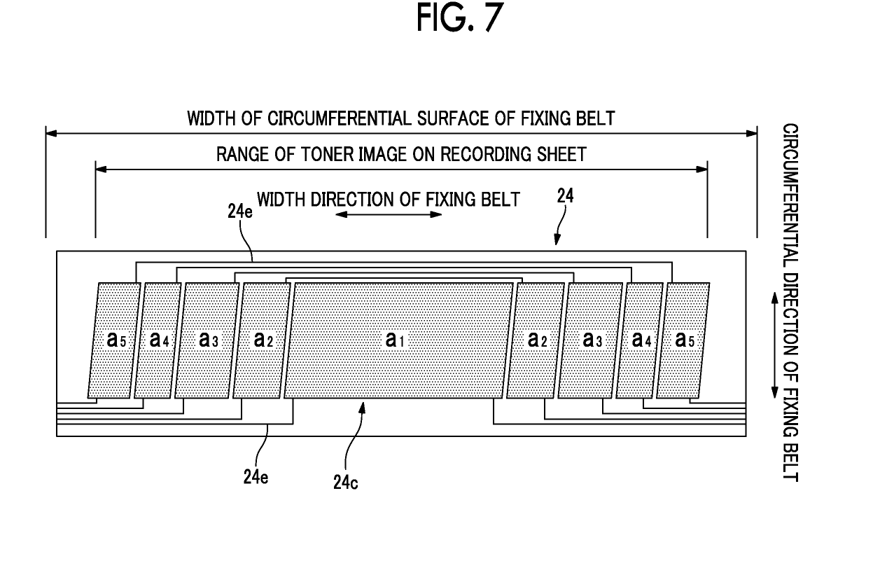

For example, the heat generation layer 24c may adopt a layer configured of stainless steel having a thickness of 30 μm, and is heated by energization. As illustrated in FIG. 7, the heat generation layer 24c is formed except for a peripheral portion of a surface on which the heating member 24 is developed, and is provided to oppose the range, within which the toner image is formed on the recording sheet, in the width direction of the circumferential surface of the fixing belt 21. Moreover, the heating member is divided into plural ranges so that energization is performed. The divided ranges are energized according to a size of the recording sheet fed to the fixing device 7, much heat is generated at a paper passing region in which much heat is transmitted to the recording sheet, and a heat generation amount is suppressed to prevent excessive heating at a non-paper passing region.

In respective ranges in which the heat generation layer 24c is divided in plural, a thin energization heating path patterned by a method such as etching is formed, and the path has a pattern in which heat is easily generated by energization. Current is supplied to the heating region via energization paths 24e that is provided on the peripheral portion of the heating member 24, and preferably, the energization paths 24e are provided on both end portions in the circumferential direction of the heating member 24, that is, regions which do not contact with the fixing belt 21 in the vicinities of the end edge supported to be fixed and the end portion becoming the free end.

Moreover, the coating layer 24d coats the heat generation layer 24c to protect the layer 24c.

In the image forming apparatus described above, the toner images having each color formed by the image forming unit 10 are overlapped on the intermediate image transfer belt 11, and are integrally transferred to the recording sheet at the position at which the secondary image transfer roll 12 opposes the intermediate image transfer belt 11. The recording sheet P is fed to the fixing device 7, and the held toner image T is overlapped with the fixing belt 21 to contact with the fixing belt 21 and passes between the pressure roll 22 and the pressing member 23. The fixing belt 21 contacts with the heating member 24 that is energized and heated, and contacts with the recording sheet in a state where the belt is heated. Moreover, the fixing belt is pressurized between the pressure roll 22 and the pressing member 23, and the toner image is fixed to the recording sheet. At this time, since the thicknesses of the heating member 24 and the fixing belt 21 are thin and have small heat capacity, the heating member and the fixing belt may be rapidly heated, power usage is decreased at a standby state, and the fixing may be rapidly realized.

In addition, in the fixing device 7, a portion of the fixing belt 21 is interposed between the pressure roll 22 and the pressing pad 25 to form a pressing section, the fixing belt is bent by the stiffness of the fixing belt from the downstream side of the pressing section to the upstream side of the pressing section in the rotating movement direction, and thus, the fixing belt is flexibly deformable in the range. Meanwhile, the heating member 24 is bent so that the cross-sectional shape is spiral, and the end portion having a smaller radius of curvature is supported to be fixed to the pressing member 23 and, as illustrated in FIGS. 3 and 4, is supported to extend outside from the position of the circumferential surface of the fixing belt 21. Moreover, the heating member contacts with the inner circumferential surface of the fixing belt 21 that is driven to be moved in a rotating manner, and is restrained to the shape along the inner circumferential surface of the fixing belt 21. In this way, the heating member 24, which is restrained in the state where the heating member is elastically deformed inside the fixing belt 21, is pressed to the inner circumferential surface of the fixing belt 21 by elastic repulsive force. Accordingly, the heating member 24 may contact with the fixing belt in a wider range of the fixing belt that is bent and is moved to be rotated. Moreover, since the radius of curvature of the heating member 24 is increased at the free end side, a force pressing the heating member 24 to the inner circumferential surface of the fixing belt 21 is also applied to the vicinity of the free end, and a difference of contact pressures is decreased in the wide range from the fixed end side to the free end side. Moreover, the fixing belt 21 which is bent to be flexibly deformed, and the heating member 24 which is flexibly deformed contact with each other, and thus, shapes of both are easily fittable to each other, and the difference of the contact pressures is suppressed from being increased.

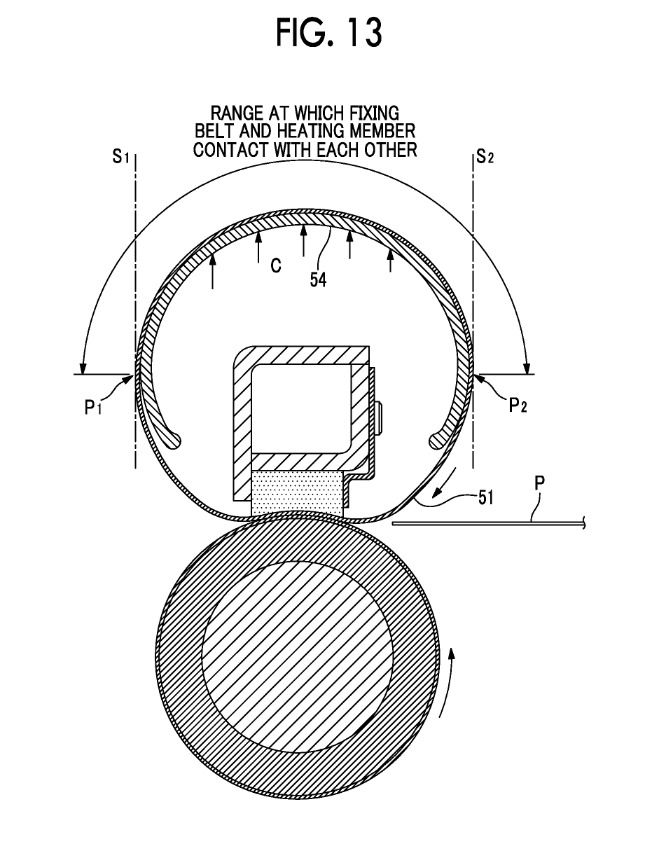

In the fixing device using the fixing belt of the related art, when the heating member placed inside the fixing belt is pressed to the fixing belt by a force in one direction, as illustrated in FIG. 13, the range in which a heating member 54 may be pressed is limited. That is, when the heating member 54 is pressed by a force in a direction shown by an arrow C inside a fixing belt 51 that is moved to be rotated with a cross-sectional shape that is a substantially circle, the heating member 54 is pressed to the fixing belt 51 between two points P₁ and P₂ at which the pressed direction C of the heating member 54 and tangential lines S₁ and S₂ are parallel to each other. Moreover, it is difficult that the contact pressure is applied beyond the range. On the other hand, for example, as illustrated in FIGS. 2 and 3, the heating member 24 is restrained inside the fixing belt 21 bending the heating member 24 and is pressed to the fixing belt 21 by the elastic repulsive force of the heating member 24, and thus, the contact pressure may be applied beyond the range. Moreover, when the fixing belt 21 is driven to rotate in the state where the cross-section from the downstream side of the pressing section, at which the fixing belt 21 is interposed between the pressure roll 22 and the pressing member 23, to the upstream side is a substantially circle, the heating member 24 may contact with the fixing belt 21 in a wide range from the downstream side of the pressing section to the upstream side. For example, when the cross-sectional shape of the fixing belt 21 is set to a circle, the heating member may contact with the fixing belt in a range in which a center angle is approximately 270°.

In this way, the heating member 24 comes into contact with the fixing belt 21 in a wide range, and thus, when the exemplary embodiment and the related art are compared to each other while transport speeds of the recording sheet P holding the toner image are the same as each other, in the exemplary embodiment, the contact range is increased, improved fixing of the toner image may be realized even when the temperature of the heating member 24 is set to be low, and an amount of power consumption may be decreased. Moreover, when the exemplary embodiment and the related art are compared to each other while set temperatures of the heating member 24 are the same as each other, in the exemplary embodiment, the contact range is increased as described above, and thus, improved fixing may be realized even when the transport speed of the recording sheet is increased.

In the fixing device 7, the heating member 24 has a spiral shape in which a distance r from the center point in the cross-sectional shape when the heating member is not restrained by the fixing belt 21 is increased in proportion to the angle. However, the cross-sectional shape when the heating member is not restrained is not limited thereto, and other shapes may be adopted as long as the heating member may contact with the fixing belt in a wide range in the circumferential direction. Preferably, the radius of curvature is gradually increased from the fixed end side to the free end side in the circumferential direction of the fixing belt. However, a portion or the entirety of the range in which the heating member contacts with the fixing belt may be a straight line.

Meanwhile, in the fixing device 7, the heating member 24 is supported to be fixed at the upstream side in the rotating movement direction of the fixing belt 21, and the end portion of the downstream side becomes the free end in which the displacement of heating member is not restrained. However, the end portion of the downstream side of the heating member 24 may be supported to be fixed, and the upstream side may be the free end. At this time, a compressive force to the fixed end side along the circumferential surface of the fixing belt 21 is applied to the heating member 24 by the friction between the fixing belt 21 and the heating member 24. The friction force between the fixing belt 21 and the heating member 24 is decreased so that the heating member 24 is not buckled by the compressive force and large deformation is not generated in the vicinity of the fixed end.

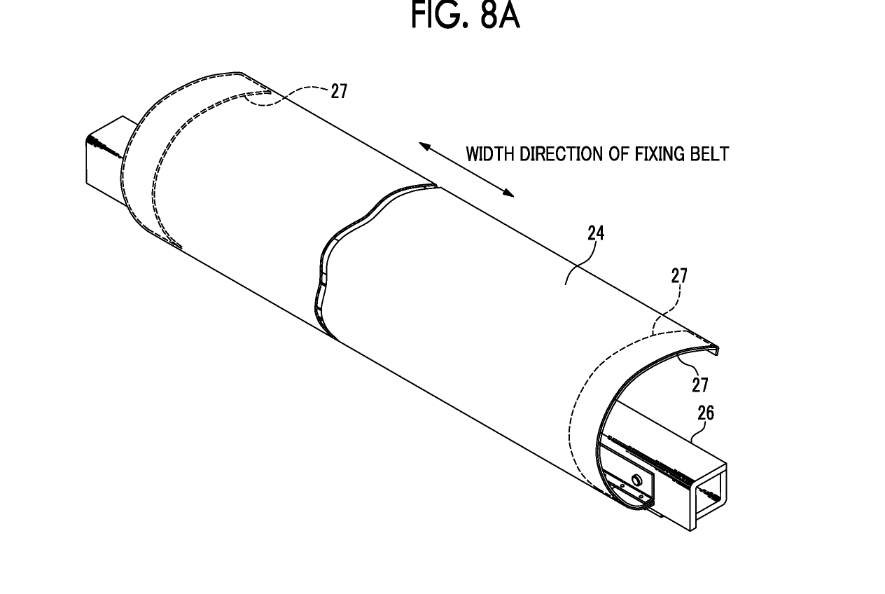

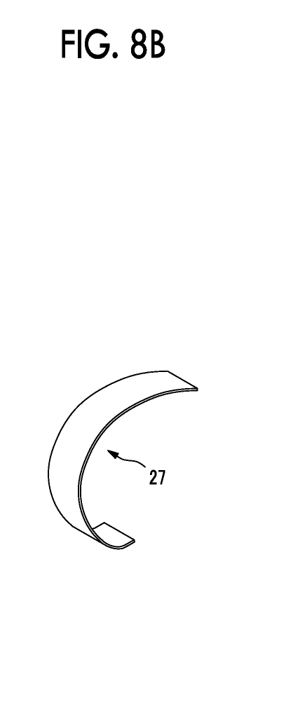

Moreover, in the heating member, as illustrated in FIG. 8A, band-shaped spring members 27 that secondarily apply the pressing force with respect to the fixing belt 21 may be provided. Each of the band-shaped spring members 27 is formed of a thin metal, which is elastically deformable, such as stainless steel. Moreover, the band-shaped spring members are overlapped with the bent inner side of the heating member 24 in both end portions of the heating member 24 in the width direction of the fixing belt 21, and are supported to be fixed along with the heating member 24 at the end portion at which the heating member 24 is supported to be fixed. Moreover, the band-shaped spring members are placed to come into close contact with the heating member 24 in the circumferential direction of the fixing belt 21.

For example, the band-shaped spring members 27 may have a thickness of approximately 0.1 mm to 0.2 mm. In addition, as illustrated in FIG. 8B, the band-shaped spring member is bent according to the shape in which the heating member 24 is bent in the circumferential direction of the fixing belt 21.

Moreover, preferably, the region in which the band-shaped spring member 27 contacts with the heating member 24 is positioned at the region in which the heat generation layer of the end portion of the heating member 24 does not exist.

By providing the band-shaped spring member 27, the band-shaped spring member 27 is deformed along with the heating member 24, and the heating member 24 is secondarily pressed to the inner circumferential surface of the fixing belt 21 by the elastic repulsive force due to the deformation. As described below, the secondary pressing force suppresses unevenness of the pressing force of the heating member 24 with respect to the fixing belt 21 in the width direction of the fixing belt 21.

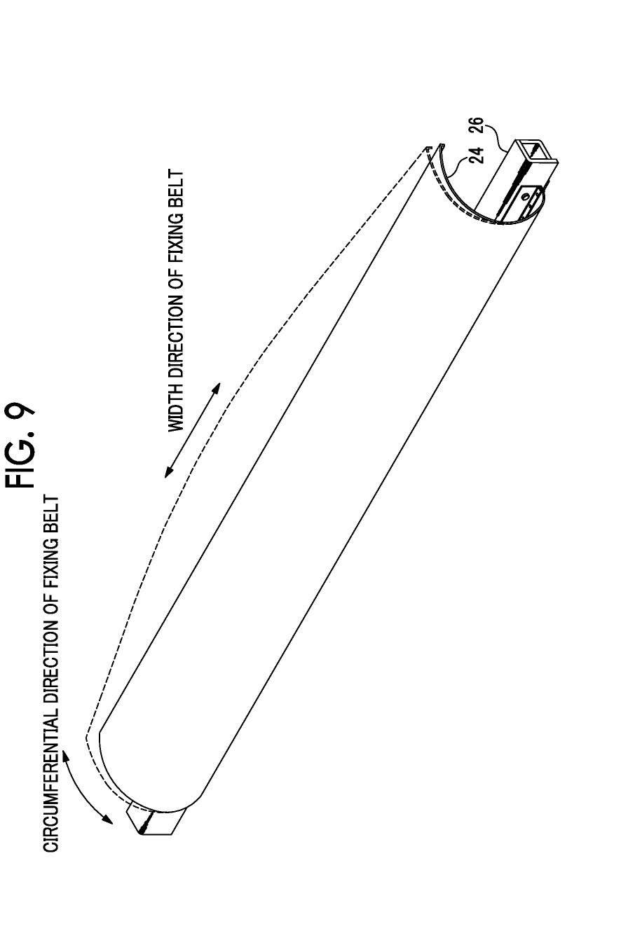

As illustrated in FIG. 9, when the heating member 24 is heated in the state where the heating member is not restrained by the fixing belt 21, the heating member may be deformed in a shape shown in a broken line in FIG. 9. That is, when the heating member 24, which is supported to be fixed at one end portion in the circumferential direction of the fixing belt 21 and is bent in the circumferential direction, is heated, the free end in the center portion in the width direction of the fixing belt 21 may be opened to be larger than the free ends of both end portions. Accordingly, in the state where the heating member 24 is placed inside the fixing belt 21 and is restrained by the fixing belt 21, the pressure force with respect to the fixing belt of the heating member 24 at the center portion in the width direction of the fixing belt 21 is larger than those of both end portions. With respect to this, the band-shaped spring members 27 are placed on both end portions of the heating member 24, and thus, the pressing force is secondarily applied, and a difference of the pressing forces with respect to the fixing belt 21 is suppressed.

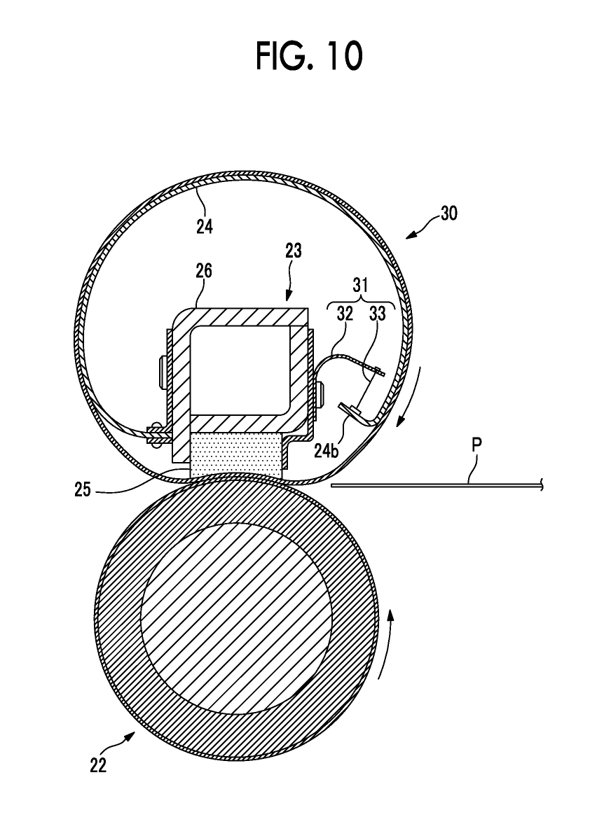

FIG. 10 is a schematic cross-sectional view illustrating a fixing device that is another exemplary embodiment of the present invention.

As the fixing device 7 illustrated in FIGS. 2 and 3, a fixing device 30 includes the fixing belt 21, the pressure roll 22, the pressing member 23, and the heating member 24. Moreover, in addition to the above-described components, the fixing device 30 includes a resistance member 31 that applies resistance to the movement of the free end of the heating member toward the downstream side in the rotating movement direction of the fixing belt 21.

The resistance member 31 includes a plate spring 32 in which one end is fixed to the support section 26 of the pressing member 23, and a wire 33 that connects the other end portion of the plate spring 32 and the tip portion of the heating member 24. The plate spring 32 is elastically deformed to be bent, and the elastic repulsive force is transmitted to the tip portion of the heating member 24 via the wire 33. The elastic repulsive force is applied to the upstream side along the rotating movement direction of the fixing belt 21 with respect to the heating member 24 in which the shape is restrained inside the fixing belt 21 having an endless shape.

Moreover, the plate spring 32 continues in the width direction of the circumferential surface of the fixing belt 21, the wires 33 are provided at a predetermined gap in the width direction, and thus, the elastic repulsive force is applied to be approximately equal in the width direction with respect to the heating member 24.

In the fixing device 30, the fixing belt 21 is driven to rotate, and thus, the friction force is applied to the downstream side in the movement direction of the fixing belt 21 in the heating member 24. The friction force is applied to be wound and fastened with respect to the heating member 24 bent inside the fixing belt 21, and the contact pressure between the fixing belt 21 and the heating member 24 is decreased. With respect to this, the resistance member 31 applies the force to the upstream side in the rotating movement direction of the fixing belt 21 with respect to the tip portion of the heating member 24. Accordingly, a decrease in the contact pressure is suppressed, and thus, stable heating of the fixing belt 21 is maintained.

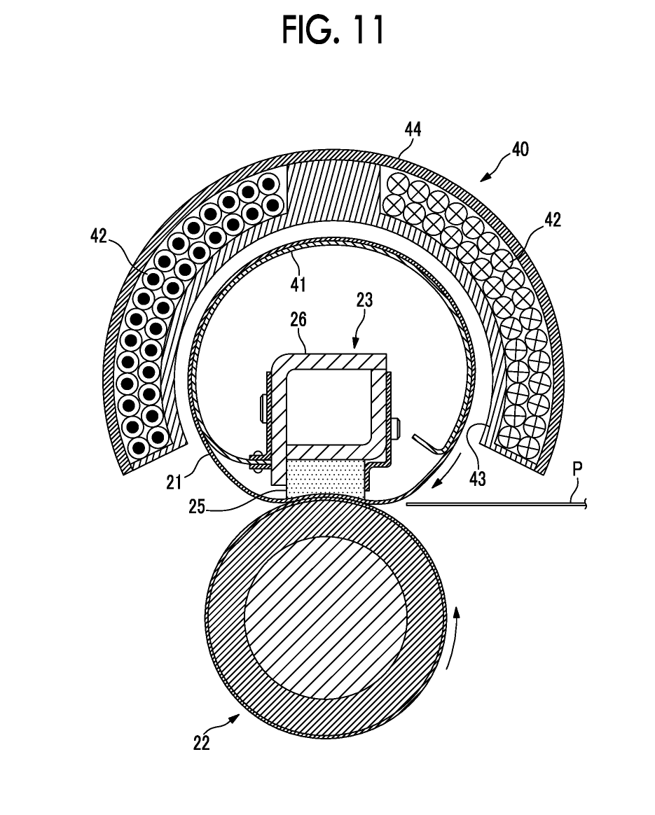

FIG. 11 is a schematic cross-sectional view illustrating a fixing device that is still another exemplary embodiment of the present invention.

As the fixing device 7 illustrated in FIGS. 2 and 3, a fixing device 40 includes the fixing belt 21, the pressure roll 22, and the pressing member 23. However, a heating member 41 used in the fixing device 40 does not include a heat generation layer by energization and includes a heat generation layer by electromagnetic induction heating. Moreover, an exciting coil 42 is provided at a position opposing the outer circumferential surface of the fixing belt 21, and a high frequency current is supplied from an exciting circuit (not illustrated) to the exciting coil 42.

For example, the heat generation layer by the electromagnetic induction heating is formed of stainless steel having magnetism and a thickness of 70 μm. The heating member 41 may include only the heat generation layer, and in the heating member, layers configured of other materials may be laminated on the heating member.

Similar to the heating member 24 used in the fixing device illustrated in FIGS. 2 and 3, the heating member 41 is flexibly and elastically deformable. Moreover, the shape of the heating member 41 is also bent to be similar to the heating member 24, is placed inside the fixing belt 21 that is driven to rotate, and contacts with the inner circumferential surface of the fixing belt 21 in a wide range in the state where the heating member 41 is elastically deformed.

The exciting coil 42 is wound to be closed along a predetermined range of the outer circumferential surface outside the fixing belt 21 having an endless shape. Moreover, the exciting coil is provided to oppose the entire width of the region that comes into contact with the toner image of the fixing belt 21. The exciting coil 42 is supported by a coil support member 43 placed to oppose the outer circumferential surface of the fixing belt 21 at an interval, and a magnetic field shield member 44 is provided on the rear surface side of the exciting coil 42 opposing the fixing belt 21.

In the fixing device 40, a high frequency current is supplied from the exciting circuit to the exciting coil 42, and thus, an eddy current is generated in the heat generation layer of the heating member 41 by electromagnetic induction. Accordingly, the heat generation layer generates heat, and the fixing belt 21 contacting with the heat generation layer is heated.

Similar to the fixing device 7 illustrated in FIG. 2, the fixing belt 21 is driven to rotate by the rotation of the pressure roll 22, interposes the recording sheet holding a toner image between the outer circumferential surface of the fixing belt 21 and the pressure roll 22, and heats and pressurizes the toner image.

The above-described image forming apparatus and the fixing device are the exemplary embodiments of the present invention, and the present invention is not limited to the exemplary embodiments.

For example, the configuration forming the toner image of the image forming apparatus may have other aspects. That is, the configuration is not limited to the aspect forming a color image but may have the aspect forming a single color toner image.

Moreover, a material, a dimension, or the like used in the pressure roll of the fixing device, a material, a shape, a dimension, or the like of the pressing pad used in the pressing member, a material, a shape, or the like of the support section supporting the pressing pad, and a material, a shape, or the like of the fixing belt may be appropriately designed.

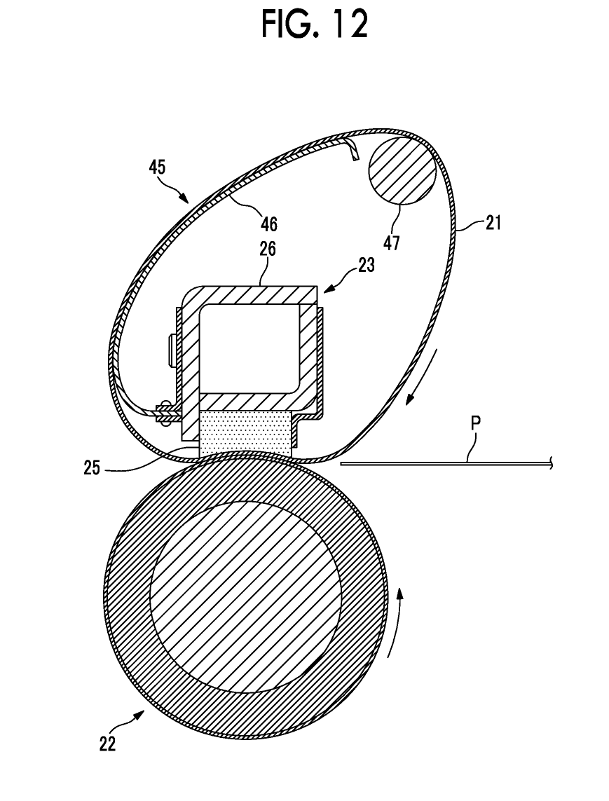

Moreover, in the exemplary embodiment, the shape of the fixing belt is maintained by the stiffness of the fixing belt from the downstream side of the pressing section, which is interposed between the pressure roll and the pressing member, to the upstream side, and thus, a member restraining the position of the fixing belt is not provided. However, the present invention is not limited to this shape. That is, as a fixing device 45 illustrated in FIG. 12, in addition to the pressing section in which the fixing belt 21 is interposed between the pressure roll 22 and the pressing member 23, a regulating member 47 restricting the position of the rotating movement of the fixing belt 21 may be provided. Moreover, the regulating member 47 may be positioned at the downstream side or the upstream side of the position at which a heating member 46 contacts with the fixing belt. The regulating member 47 may appropriately adopts a roll shaped member, a pad shaped member, or the like.

Moreover, also in heating member, the cross-sectional configuration, the shape when the heating member is not restrained by the fixing belt, or the like is not limited to the exemplary embodiments, and may be appropriately designed within the scope of the present invention.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A fixing device comprising:
a fixing belt that is formed in an endless shape, is driven to rotate, and includes an outer circumferential surface pressed to a recording sheet holding a toner image; and
a thin plate shaped heating member that contacts with an inner circumferential surface of the fixing belt to generate heat and heats the fixing belt,
wherein the heating member is supported to be fixed at one end portion in a circumferential direction of the fixing belt, contacts with the fixing belt along the circumferential direction, is elastically deformed so that a shape of the heating member is restrained by the fixing belt, and is pressed to the inner circumferential surface of the fixing belt by an elastic repulsive force.

2. The fixing device according to claim 1, wherein
the heating member is bent so that a surface of a side contacting with the fixing belt is convex in a cross-section along a rotating movement direction of the fixing belt, and a radius of curvature is increased from the one end portion side supported to be fixed to the other end side in a contact range of the heating member and the fixing belt.

3. The fixing device according to claim 2, wherein
a shape of the heating member having the radius of curvature increased from the one end portion side supported to be fixed to the other end side is a portion of a spiral curve in which a distance r from a center point is increased to be proportional to an angle θ.

4. The fixing device according to claim 1, further comprising:
a pressure roll that is rotated; and
a pressing member that opposes the pressure roll, wherein
a portion in the circumferential direction of the fixing belt is interposed to be held between the pressure roll and the pressing member, and
the fixing belt is driven to rotate so that a curved shape of the fixing belt is maintained by stiffness of the fixing belt from a downstream side of a pressing section interposed between the pressure roll and the pressing member to an upstream side of the pressing section.

5. The fixing device according to claim 2, further comprising:
a pressure roll that is rotated; and
a pressing member that opposes the pressure roll, wherein
a portion in the circumferential direction of the fixing belt is interposed to be held between the pressure roll and the pressing member, and
the fixing belt is driven to rotate so that a curved shape of the fixing belt is maintained by stiffness of the fixing belt from a downstream side of a pressing section interposed between the pressure roll and the pressing member to an upstream side of the pressing section.

6. The fixing device according to claim 3, further comprising:
a pressure roll that is rotated; and
a pressing member that opposes the pressure roll, wherein
a portion in the circumferential direction of the fixing belt is interposed to be held between the pressure roll and the pressing member, and
the fixing belt is driven to rotate so that a curved shape of the fixing belt is maintained by stiffness of the fixing belt from a downstream side of a pressing section interposed between the pressure roll and the pressing member to an upstream side of the pressing section.

7. The fixing device according to claim 4, wherein
the heating member contacts with the fixing belt beyond a range between two positions in which two tangential lines are parallel to each other, from the downstream side of the pressing section in which the fixing belt is interposed between the pressure roll and the pressing member to the upstream side.

8. The fixing device according to claim 5, wherein
the heating member contacts with the fixing belt beyond a range between two positions in which two tangential lines are parallel to each other, from the downstream side of the pressing section in which the fixing belt is interposed between the pressure roll and the pressing member to the upstream side.

9. The fixing device according to claim 6, wherein
the heating member contacts with the fixing belt beyond a range between two positions in which two tangential lines are parallel to each other, from the downstream side of the pressing section in which the fixing belt is interposed between the pressure roll and the pressing member to the upstream side.

10. The fixing device according to claim 1, wherein
an end portion of the upstream side of the heating member in the rotating movement direction of the fixing belt is supported to be fixed.

11. The fixing device according to claim 2, wherein
an end portion of the upstream side of the heating member in the rotating movement direction of the fixing belt is supported to be fixed.

12. The fixing device according to claim 3, wherein
an end portion of the upstream side of the heating member in the rotating movement direction of the fixing belt is supported to be fixed.

13. The fixing device according to claim 4, wherein
an end portion of the upstream side of the heating member in the rotating movement direction of the fixing belt is supported to be fixed.

14. The fixing device according to claim 5, wherein
an end portion of the upstream side of the heating member in the rotating movement direction of the fixing belt is supported to be fixed.

15. The fixing device according to claim 6, wherein
an end portion of the upstream side of the heating member in the rotating movement direction of the fixing belt is supported to be fixed.

16. The fixing device according to claim 7, wherein
an end portion of the upstream side of the heating member in the rotating movement direction of the fixing belt is supported to be fixed.

17. The fixing device according to claim 1, further comprising:
a resistance member that applies resistance to a movement of the heating member in the circumferential direction of the fixing belt, at an end portion opposite to the end portion supported to be fixed in the heating member.

18. The fixing device according to claim 1, wherein
a band-shaped spring member that secondarily applies a force pressing the heating member to the fixing belt is provided on both end portions of the heating member in a width direction of the fixing belt.

19. The fixing device according to claim 1, wherein
the heating member includes:
a metal layer that adjusts stiffness with respect to bending of the heating member;
an insulating layer that is laminated on a surface of a side opposite to the side of the metal layer contacting with the fixing belt; and
a heat generation layer that is laminated on the insulating layer and is heated by energization.

20. An image forming apparatus comprising:
an image holding member in which an electrostatic latent image is formed on an endless shaped circumferential surface;
a developing device that transfers toner to the electrostatic latent image to be developed;
a transfer unit that transfers a toner image formed on the image holding member to a recording sheet; and
the fixing device according to claim 1 that fixes the toner image transferred to the recording sheet.
